(19) United States
(12) Patent Application Publication
(10) Pub. No.: US 2018/0036895 A1
(43) Pub. Date: Feb. 8, 2018

(54) SNAP ON AND OFF MULTI-SIZE INTERCHANGEABLE BLADE CARTRIDGES WITH HANDLE

(71) Applicant: Sharidan L. Stiles, Redding, CA (US)

(72) Inventor: Sharidan L. Stiles, Redding, CA (US)

(21) Appl. No.: 15/652,032

(22) Filed: Jul. 17, 2017

Related U.S. Application Data
(63) Continuation-in-part of application No. 14/820,343, filed on Aug. 6, 2015, now Pat. No. 9,707,689.
Application No. 14/820,343 is a continuation of application No. 11/775,688, filed on Jul. 10, 2007, now Pat. No. 9,108,329.
Application No. 11/775,688 is a continuation-in-part of application No. 10/648,686, filed on Aug. 25, 2003, now abandoned.
Application No. 10/648,686 is a continuation-in-part of application No. 10/219,095, filed on Aug. 13, 2002, now abandoned.
Application No. 10/219,095 is a continuation of application No. 09/725,789, filed on Nov. 29, 2000, now abandoned.
(60) Provisional application No. 60/830,952, filed on Jul. 14, 2006.
(60) Provisional application No. 60/245,397, filed on Nov. 1, 2000.

(51) Int. Cl. B26B 21/40; B26B 21/14; B26B 21/22; B26B 21/16; B26B 21/52; B26B 21/06

(52) U.S. Cl. CPC B26B 21/4031; B26B 21/523; B26B 21/522; B26B 21/521; B26B 21/4018; B26B 21/06; B26B 21/22; B26B 21/16; B26B 21/14; B26B 21/4012

(57) ABSTRACT

A hand-held razor that has a “snap on and off” device to attach a single or multiple blades of a smaller dimension, e. g., of one inch or less, embodied as part of an integrated replaceable razor blade cartridge, by using retention.

### CROSS-REFERENCE TO RELATED APPLICATIONS

The present application is a continuation in part of U.S. application Ser. No. 14/820,343, filed Aug. 6, 2015, which is a continuation of U.S. application Ser. No. 11/775,688, filed Jul. 10, 2007 and issued as U.S. Pat. No. 9,108,329 on Aug. 18, 2015, which claims the benefit under 35 U.S.C. §119(e) of U.S. Provisional Application No. 60/830,952, filed Jul. 14, 2006; U.S. application Ser. No. 11/775,688 is also a continuation-in-part of U.S. application Ser. No. 10/648,686, filed Aug. 25, 2003, now abandoned, which is a continuation-in-part of U.S. application Ser. No. 10/219,095 filed on Aug. 13, 2002, now abandoned, which is a continuation application of U.S. application Ser. No. 09/725,789 filed on Nov. 29, 2000, now abandoned, which claims the benefit under 35 U.S.C. §119(e) of U.S. Provisional Application No. 61/245,397 filed on Nov. 1, 2000. The disclosures of all of the above-referenced prior applications, publications, and patents are considered part of the disclosure of this application, and are incorporated by reference herein in their entirety.

### BACKGROUND OF THE INVENTION

### Field of the Invention

The present invention relates to dispensing disposable razor blade cartridges of different widths and sizes from a dispenser onto a non-disposable handle.

### Description of the Related Art

Razor blade cartridges are typically one size fit's all. Stiles razor cartridges are not; these are cartridges that contain blades sized from 1 inch and less for detailed shaving that by removed from a dispenser by connecting the handle to the cartridge while the cartridge is still retained in the dispenser. The user then pivotally enters the handle with prong into the cartridge, the handle with respect to the dispenser using leverage of the handle against a friction or interference fit of projection that holds the cartridge body, and frees the cartridge from the dispenser.

### SUMMARY OF THE INVENTION

The systems and methods have several features, no single one of which is solely responsible for its desirable attributes. Without limiting the scope as expressed by the claims that follow, its more prominent features will now be discussed briefly. After considering this discussion, and particularly after reading the section entitled “Detailed Description of the Preferred Embodiments” one will understand how the features of the system and methods provide several advantages over traditional systems and methods.

The present invention is a styling and grooming razor used for removing unwanted body hair in hard to reach or awkward places. By having the ability to have razor blade cartridges that are in different sizes and replaceable for one handle allows the razor to be used to groom the eyebrows, moustache, nose, lip, sideburns scalp, abdomen, bikini, toes, scalp art, etc. The razor blade cartridges are very small in comparison to conventional razor blades. For example, the razor blade cartridges cutting edge are 1 inch and less in sizes. Further, each of the different size cartridges are interchangeable and disposable on the same razor handle, and may have single or multiple cutting edges. Alternatively, the razor handle may be integrally molded of plastic and or metal etc. and provide a number of different fixed blade widths in a disposable form.

In some aspects, the razor blade cartridge further comprises a second or third razor blade.

In another aspect, the personal styling razor has a lower longitudinal portion that comprises a first curved shape and a middle longitudinal portion that comprises a second curved shape and wherein the first and second curved shapes form an ergonomically advantageous grip for the personal styling razor.

In yet another aspect, the personal styling razor further comprises a glide surface area and a blade area, wherein the glide surface area is larger than the blade area.

### BRIEF DESCRIPTION OF THE DRAWINGS

FIG. 1 is a front perspective view of an embodiment of the razor.

FIG. 2 is a side perspective view of the razor of FIG. 1.

FIG. 3 is a top perspective view of the razor of FIG. 1.

FIG. 4 is a top perspective view of a portion of the razor of FIG. 1 taken across section A-A of FIG. 2.

FIG. 5 is a side perspective view of an alternative embodiment of the inventive razor having a replaceable blade portion.

FIG. 6 is an example of front view of a razor blade cartridge of an embodiment of the razor of FIG. 1.

### DESCRIPTION OF THE PREFERRED EMBODIMENTS

Embodiments of the invention will now be described with reference to the accompanying figures, wherein like numerals refer to like elements throughout. The terminology used in the description presented herein is not intended to be interpreted in any limited or restrictive manner simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

Embodiments of the present invention relate to a styling and grooming razor used for removing unwanted body hair in hard-to-reach or awkward places. Additionally, the razor of these embodiments can be used for shaving with a high degree of detail for safety and ornamental shaving. For example, the razor could be used to groom the eyebrows, moustache, nose, sideburns, scalp, abdomen, bikini area, toes and other parts of the body. Unlike prior razors, the present razors are specifically designed to enable the user to shave unwanted hair close to the skin with great precision and detail. Previous small razors were designed only to permit trimming of hair from orifices such as the nose or ear, or had other design features which prohibited their use to precisely shave by cutting unwanted hair close to the root or at the surface of the skin this the difference between “shaving” and “trimming”. Certain embodiments are able to accomplish such effects because the size of the razor blades in cartridge, furthermore, in certain embodiments, each of the different size razor blade cartridges are interchangeable for a non-disposable razor handle, and can have single or multiple cutting edges.

Typically two types of razors are sold. The disposable razor includes a handle and angled head having a fixed blade or twin fixed blades as a single, integrally molded device, which may be thrown away when the blade has become too dull for effective shaving. The standard non-disposable razor includes a better quality handle and disposable razor blade cartridges.

While both types of razors are extremely popular, the razor blades are fairly wide and are typically only effective for shaving large surfaces such as facial hair or leg hair, for example. Embodiments of the present invention provide a significant improvement in that a variety of narrower width blades can be provided to facilitate use of a razor for styling and grooming of smaller or more awkward areas of the body and then switch to a small area to shave such as bikini or eyebrows. Additionally, other embodiments facilitate the use of different sized razor blade cartridges such that large amounts of hair can be removed as in common wider razor blade cartridge and also very detailed shaving can be performed with the same handle by exchanging the cartridge.

FIG. 1. Shows a front view of an embodiment of the invention having a handle 10 and blade attachment portion 20.

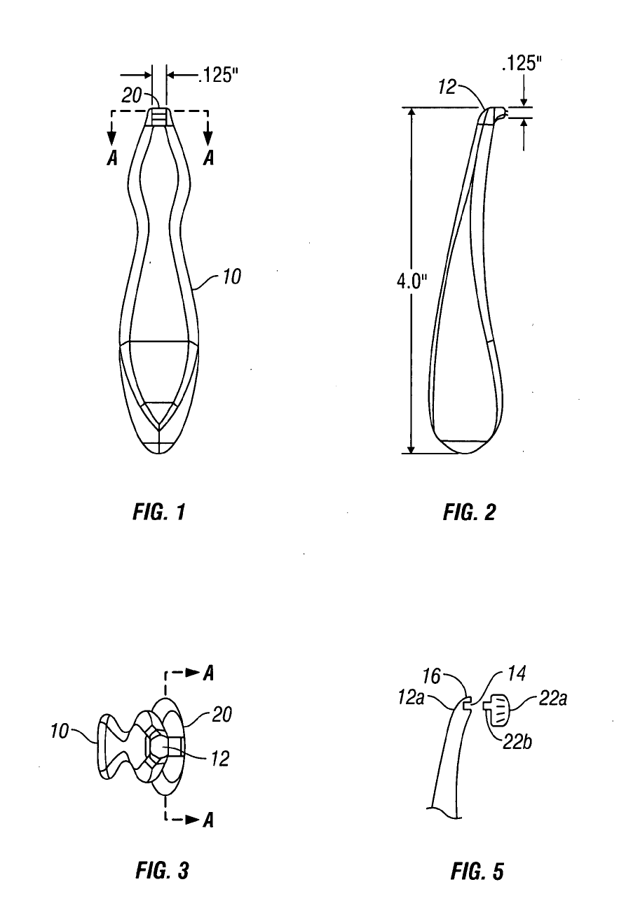

FIG. 2. As shown in the side view of an embodiment illustrated by the blade attachment portion 20 is part of an angular head portion 12 of the handle 10.

FIG. 3. Illustrates how the blade attachment portion 20 is integrated with the handle 10.

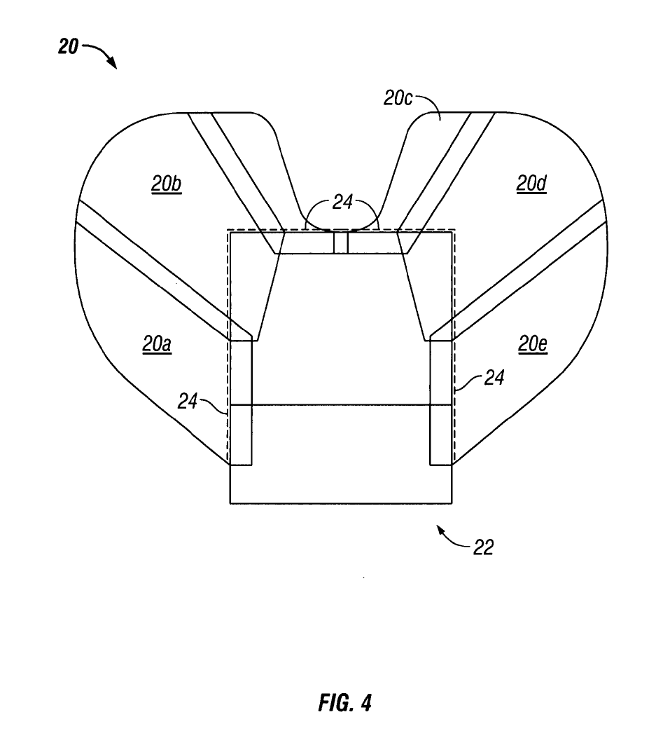

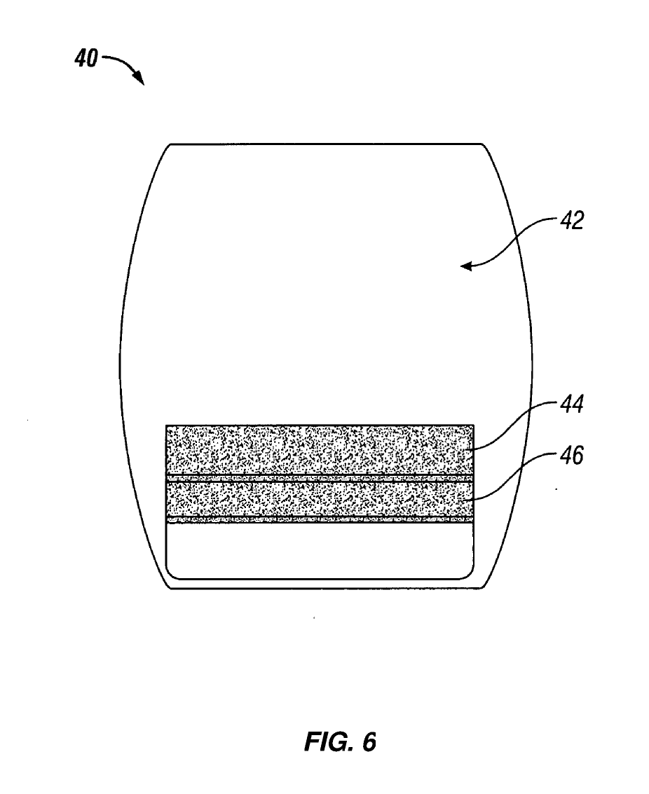

FIG. 4. Provides additional detail of an example regarding the inclusion of a razor blade 22 in the razor blade cartridge attachment portion 20. In certain embodiments, the blade attachment portion 20 includes five sections 20a-20e which may be organized in a fan-like arrangement and then molded together. Thus, portions 20a and 20e overlap portions 20b and 20d, respectively. Likewise, the rear portion 20c also overlaps portions 20b and 20d. The inside lip of each portion includes a recess 24 (dashed line) to securely accommodate one or more blades. A machine inserts a steel blade portion 22 of the desired size into the recess. As noted above, the width of the steel razor blade be approximately one inch or less, and the dimensions of the blade attachment portion 20 will vary accordingly to accommodate a particular blade size; although other blade sizes can be used.

FIG. 5. In this embodiment, the angled head 12a includes a retention mechanism 14 which mates with a clip 22b on a replaceable blade cartridge 22a in a snap on and off manner to secure the cartridge to the head 12a. Such a retention mechanism 14 and clip 22b it can snap into and out of place by resilience of the various components. The retention mechanism 14 may include a release 16, which is hand actuated to allow removal and replacement of the cartridge. Embodiments of the cartridge snap off by applying force to the back part of the cartridge. Yet other embodiments employ engaging and disengaging mechanisms that can alternately engage and disengage the cartridge with the head 12a by depressing or releasing an actuator on the back of the handle 10.

What is claimed is:

1. A razor handle, comprising:
a snap on and off apparatus that has one prong that inserts into a razor blade cartridge with sizes ranging less than one inch in width for the shaving area; and
a single, double or triple razor blade inserted into the razor blade cartridge portion.

2. A razor handle, comprising a snap on and off apparatus that has one prong that inserts into a razor blade cartridge.

3. A razor handle, comprising:
a snap on and off apparatus with button release mechanism to eject razor blade cartridge with sizes ranging less than one inch in width for the shaving area; and
a single, double or triple razor blade inserted into the razor blade cartridge portion.

4. A razor handle, comprising a snap on and off apparatus with button release mechanism to eject razor blade cartridge portion.

5. A razor blade cartridge portion with sizes ranging less than one inch in width for the shaving cutting edge area.

6. A razor blade cartridge portion with shaving cutting edge area having and a single, double or triple razor blade inserted into the razor blade cartridge portion.

7. The razor of claim 1, wherein the razor blade cartridge portion snaps into the handle portion.

8. A razor blade cartridges range in various sizes of 1 inch and less width for interchangeable applications.

9. A razor blade cartridge that may contain multiple blade sizes of 1 inch and less width for personal choice of applications.

10. The razor of claim 1, wherein the razor has an overall maximum length of less than or equal to about 7.0 inches and may have curvy or straight shape.
